(19) United States
(12) Patent Application Publication
(10) Pub. No.: US 2015/0101274 A1
(43) Pub. Date: Apr. 16, 2015

(54) Windows, Stops, Glazing Rings, and Related Assemblies, Systems, and Methods

(71) Applicant: Rehme Custom Doors and Lighting Inc., Spicewood, TX (US)

(72) Inventor: Peter Rehme, Spicewood, TX (US)

(73) Assignee: Rehme Custom Doors and Lighting Inc., Spicewood, TX (US)

(21) Appl. No.: 14/055,304

(22) Filed: Oct. 16, 2013

(51) Int. Cl. E06B 3/58; E06B 3/54

(52) U.S. Cl. CPC E06B 3/5878; E06B 3/5454
USPC 52/204.62

(57) ABSTRACT

Stops, glazing rings, windows, doors, etc. Some embodiments provide stops for securing window panes in windows. Some stops define elongated bodies with longitudinal axes, window pane-facing sides, frame member-facing sides, and sides at least partially set at acute angles to the other sides. Additionally, the frame member-facing sides also define grooves which are generally parallel to the axes and which can receive splines to seal the panes. Some stops have solid cross-sections which can be triangular. If desired, some stops are extruded and are orthogonally joined to one another to form glazing rings. These rings can be installed in windows, doors, etc. along with sealing splines to secure window panes against the window frame members. Moreover, they can comprise at least two stops. Furthermore, the frame members of embodiments are thermally broken.

### BACKGROUND

Builders must solve a number of technical problems when building homes, office buildings, factories, and the like. For instance, the doors and windows must be sturdy/stiff enough to withstand wind loads, potentially wide temperature fluctuations (over the months and years of their service lives), etc. while also sealing the building against water/air infiltration and/or exfiltration. Of course, the windows must also limit conductive, convective, and/or radiative heat transfer into/out of the building.

With homes in particular, and offices and other facilities to some extent, styling and appearance can be important factors too. Thus, architects tend to create unique designs for many buildings or at least designs that stand out or otherwise distinguish them from nearby and/or other buildings. As a result, the doors and windows of buildings vary greatly in design, appearance, functionality, etc. while solving some or all of the foregoing problems as well potentially others. In addition, it is often desired that windows (and/or doors) be glazed, installed, serviced, etc. with clean, simple, and/or inexpensive methods.

### SUMMARY

The following presents a simplified summary in order to provide an understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, methods, etc. for securing window panes in windows and more specifically it provides window-stops and glazing rings for securing panes of insulated glass in multi-lite windows and/or doors while providing beveled (or otherwise ornamentally pleasing) external-facing surfaces.

Embodiments of the current disclosure provide steel frame window and door systems fabricated from standard, off-the-shelf, dimensioned steel components. These components can be fabricated with metal-inert-gas (MIG) and/or tungsten-inert gas (TIG) welding processes according to shop drawings approved by the customers and per the architects' visions. Moreover, embodiments provide “true divided lite” (TDL) systems although they can be used to provide “simulated divided lite” (SDL) systems. Lites of embodiments are divided by frame members (for instance, “T-bars”) fabricated from 2 pieces of flat-bar that are welded together with a TIG process. Generally, one bar (for instance a horizontal bar) of the “T” is 3/16 inch by 1¼ inch and the other bar (the vertical bar) is ⅛ inch by 1¾ inch. In some embodiments the dimensions of these components will be larger to add strength for bigger panes if desired. Of course, smaller components are provided as well.

The main frames of an assembly, the door panel frames, and the window frames of embodiments are built from ½ inch by 2 inch solid flat-bar in some embodiments. Outside the main frame is a nailing fin, made from ⅛ inch by 2 inch flat bar, which can provide rigidity to the assembly and can give the builder a structure with which to use screws (or other fasteners) to attach the assembly to various buildings. The nailing fins of embodiments also provide a structure with which to waterproof the window since the seam between the main frame and nailing fin can be sealed. A flat-bar “fixed stop” (often 3/16 inch by ⅝ inch) can be welded to the inside of the frames (typically ½ inch by 2 inch) thereby providing structure to which to glaze the window panes of insulated glass (IG) and/or other materials.

Furthermore, each lite can be trimmed out with removable stops after it is glazed with the IG units. The removable stops can be fabricated from extruded triangular aluminum bars. Moreover, the stops can be miter cut into 4 (or more or fewer) pieces and TIG welded into a unitary glazing ring that fits into the lite openings. Glazing rings of the current embodiment allow users to avoid having to assemble much of the window on site and/or at the time of glazing. Furthermore, the glazing rings of the current embodiment have dovetail grooves on one side that receive foam splines. When the foam splines are installed into the dovetail grooves, they extend there from and fill the gap between the glazing ring and the surrounding frame members. Further still, foam splines of the current embodiment engage one side of the “T-bars” (and/or frame members) and create friction there between. This friction can hold the glazing rings in place during the glazing process while silicone-based wet-seal (or other wet seal) at the edge of the IGs cure. Thus, glazing methods, which use such removable glazing rings, can create an attractive beveled appearance for the lites while facilitating the glazer's job.

Some embodiments provide stops for securing windowpanes against frame members in windows. Such stops can comprise an extruded and elongated stop body defining a longitudinal axis. Some stops define sides which will face the window pane, which will face the frame member, and which will form acute angles between the pane-facing sides and the frame-facing sides. Therefore, the window-stop creates a beveled surface between the frame member and the window pane. These stops also define solid and triangular cross-sections. Moreover, the frame member-facing sides further define grooves parallel to the longitudinal axis that are adapted to receive a spline. The spline of the current embodiment forms a seal between the stop and the window pane.

Some embodiments provide stops for securing window panes against frame members in windows. The stops of the current embodiment define elongated stop bodies which further define longitudinal axes, window pane-facing sides, frame member-facing sides, and sides at least partially set at acute angles to the other sides. Additionally, the frame-facing sides can define dovetail-shaped grooves (generally parallel to the longitudinal axes) which can receive splines to form seals between the stops and the window panes. Some stops of the current embodiment also define generally solid cross-sections which can be triangular. If desired, stops of the current embodiment can be extruded and can be orthogonally joined to one another to form glazing rings. These glazing rings can be installed in windows, doors, etc. (along with splines) to seal the windowpanes.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other novel and nonobvious features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually corresponds to the figure in which the reference number first appears. The use of the same reference numbers in different figures usually indicates similar or identical items.

FIG. 1 illustrates photographs of a true divided lite window and a simulated divided lite window.

FIG. 2 illustrates a true divided lite door.

FIG. 3 illustrates a cross-sectional view of a thermally broken frame member.

FIG. 4 illustrates a cross-sectional view of another double glazed window.

FIG. 5 illustrates a cross-sectional view of yet another double glazed window.

FIG. 6 illustrates a cross-sectional view of another double glazed window.

FIG. 7 illustrates a cross-sectional view of still another double glazed window.

FIG. 8 illustrates a photograph of a pair of stops.

FIG. 9 illustrates an end elevation view of a stop.

FIG. 10 illustrates an end elevation view of another stop.

FIG. 11 illustrates a photograph of a glazing ring.

FIG. 12A-C illustrate a thermally broken muntin bar, T-bar, or frame member.

FIG. 13 illustrates a door/window hinge.

FIG. 14 illustrates a cross-sectional view of a door/window hinge.

FIG. 15 illustrates an end view of a door/window hinge.

FIG. 16 illustrates a photograph of partially disassembled door/window hinge.

FIG. 17 illustrates a photograph of another partially disassembled door/window hinge.

FIG. 18 illustrates a method of manufacturing a window.

### DETAILED DESCRIPTION

This document discloses systems, apparatus, methods, etc. for securing window panes in windows and more specifically it provides window-stops and glazing rings for securing panes of insulated glass in multi-lite windows and/or doors while providing beveled external-facing surfaces. The current disclosure also provides window/door hinges and thermally broken window frames. Hinges of embodiments are made from materials of superior grade, can be (nearly) maintenance free, and/or can be self-lubricating. Therefore, doors and windows of the current embodiment work and “feel” better when used. Moreover, doors and windows of the current embodiment can be custom-built, one-of-a-kind products which still enjoy fabrication efficiencies and costs more often associated with mass-produced doors and windows.

Some embodiments provide simple, low-profile, removable aluminum stops for easy glass installation and replacement. Windows of embodiments include minimal-sightline mullions and/or muntins while also maintaining superior structural integrity. These frame members can be coated with a high quality, 2-part epoxy and/or paints. Moreover, these frames can also provide waterproof nailing (attachment) flanges or through jamb mounting holes for new construction and/or remodel applications. The window frames of embodiments offer unitized construction with little or no on-site assembly required. Furthermore, frames of such embodiments can be used with single or double-paned glass preparations.

In certain, non-limiting embodiments, steel window and door systems are designed to receive ⅝ inch insulated glass (IG) units, and have a removable aluminum stop fabricated from ½ inch square bar and/or triangular extrusions. These IG units and removable stops can be field-glazed from the exterior using structural silicone. In accordance with the current embodiment, no mechanical fasteners are required to secure the glass, the glazing rings, and/or the stops. Such glazing methods can be superior to other glazing methods because they allow for easy IG unit installation and replacement. In the event a window of the current embodiment is damaged, almost any glass professional (or other user) can cut out the removable aluminum, steel, etc. stop, and then re-silicone the new IG unit because of the simplicity of window and/or door systems of the current embodiment.

Many heretofore-available steel window and door systems require relatively large numbers of screws, mechanical fasteners, and/or clips to keep track of. Glazers often do not enjoy working on such systems because the clips often break and the fasteners get lost or become cross-threaded. And, at least some heretofore-available steel window and door systems (that are putty glazed) require highly skilled professionals with specialized tools and equipment to install and/or repair such window and door units. Putty glazing in the field, moreover, is an art and it can be difficult to find local professionals with the skills to make the replacement putty-glazed window look exactly like the adjacent putty glazed windows, especially if they are in a hurry.

Door and window systems of the current embodiment are field glazed thereby allowing users, homeowners, architects, building managers, etc. to work with local glass providers to obtain the right glass (or other windowing materials) for given applications. Thus, users get to choose certain glass characteristics such as low-E (emissivity), color, thermal performance, UV (ultraviolet) performance, spacer color, material, and/or others. Users can therefore match their replacement glass with the glass in the rest of the building. Users can also avoid being essentially limited to replacement glass supplied by the manufacturer who supplied the original glass in their building and/or windows.

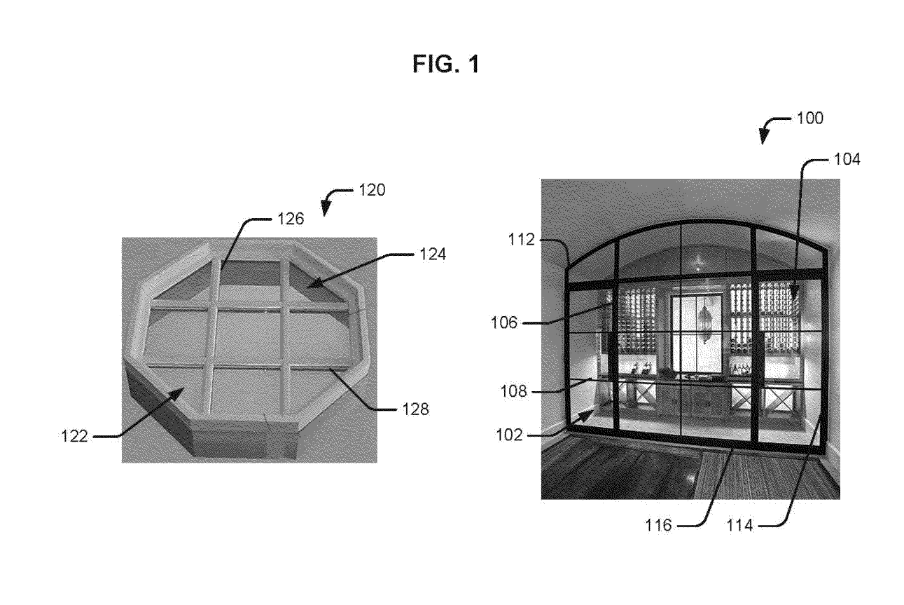

FIG. 1 illustrates a photograph of a true divided lite window and a simulated divided lite window. More specifically, and with reference to true divided lite windows, FIG. 1 illustrates true divided lites (TDL) 100, sashes 102, lites 104, stiles 106, rails 108, muntins, an arch top or circle top 112, a jamb 114, and a bottom rail 116. With reference to the simulated divided lite window, FIG. 1 also illustrates simulated divided lites (SDL) 120, a grille or grid 122, lites 124, stiles 126 (or vertical frame member), and rails 128 (or horizontal frame member).

While the TDLs 100 of the current embodiment exhibit many improved functional/structural characteristics (for instance improved thermal performance), they also have a generally more pleasing, elegant appearance than the SDLs 120 for a given window (or set of windows) the TDLs 100 present more transparent or “glass” area to the user then the SDLs 120. As those skilled in the art will appreciate, users generally associate SDLs with cheaper or inferior products and/or workmanship. TDLs, though, enjoy a more expensive or higher quality/prestige appearance. Moreover, stops (disclosed further herein) of the current embodiment facilitate many of the functional and appearance related characteristics of the TDLs 100. For instance, these stops facilitate lites 104 having shapes other than rectangular such as those associated with the arch top 112. And, as disclosed further herein, muntins of the current embodiment provided better thermal performance than muntins heretofore available.

With continuing reference to FIG. 1, the TDLs 100 are composed of a number of separate, distinct lites 104. These lites 104 are defined by the window panes and/or the stiles 106, rails 108, jambs 114, and other parts of the overall window frame. Generally, the stiles 106 run vertically across the windows/doors while the rails 108 run horizontally. Certain other frame members though can run in other directions and/or be curved, angled, etc. Indeed, arch top 112 includes frame members which are curved with a variable radius of curvature. These frame members hold the windowpanes of the various lites 104 in pre-determined, fixed relationships with each other and help the individual panes (as well as the overall window) resist environmental forces such as wind-loads. Certain frame members can also aid in sealing the individual windowpanes.

Note also that the structure formed by the TDLs 100 need not be confined to windows. Rather, doors, (transparent) ceilings, floors, etc. and other structures can incorporate the TDLs 100, sashes 102, lites 104, stiles 106, rails 108, stops (not shown in FIG. 1), and other components, apparatus, systems, etc. provided by the current embodiment. Moreover, while the window panes of the various lites 104 can be glass, they can (in the alternative or in addition) be formed from plexi-glass, plastic, low E (emissivity) glass, quartz, etc. and can be single paned, double-paned, etc.

In contrast, to the TDLs 100, many heretofore available windows present SDLs 120 to the viewer. These SDLs 120 merely simulate truly divided or separate lites 104. Instead of being truly divided and separate lites 104, the lites 124 are actually areas of a single, large IG unit or pane of glass with the grille 122 overlaid thereon. Thus, replacement or maintenance of one SDL lite 124 often requires servicing or otherwise manipulating the entire SDL 120 structure. For instance, should one SDL lite 124 be broken or otherwise damaged, the entire pane incorporating all simulated lites 124 must be replaced. In contrast, service to one true lite 104 can often be accomplished without disturbing the other true lites 104. These features of the TDL 100 allow for quicker, more efficient, less costly, and safer servicing of the TDL 100 as compared to the SDL 120. In addition, the TDL 100 structure can be largely manufactured remotely from a construction site (for instance, in a factory, shop, depot, etc. with the IG units or other panes being installed on site) whereas the SDL 120 must often be fabricated from piece parts on site. Construction of buildings and other structures incorporating TDLs 100 can therefore be correspondingly less expensive, faster, with fewer defects, etc. than heretofore possible.

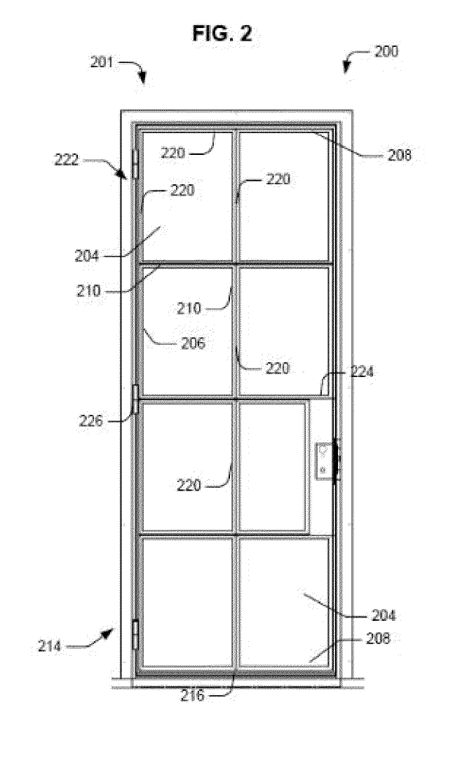

FIG. 2 illustrates a true divided lite door. More specifically, FIG. 2 illustrates true divided lites (TDL) 200, a frame 201, lites 204, stiles 206, rails 208, muntin bars 210, jambs 214, a threshold 216, stops 220, glazing rings 222, a lock box 224, and one or more hinges 226. In other words, FIG. 2 illustrates a door incorporating the TDLs 200. While the lock box 224 and hinges 226 facilitate the kinematic functioning of the door, the various frame members (and/or their component parts) frame the individual lites 204 including those bordering the lock box 224 and/or the hinges 226.

Again, any particular lite can comprise one or more stiles 206, rails 208, muntin bars 210, jambs, 214, stops 220, etc. and holds the window pane(s) of a corresponding lite 204 in place. It might be worth noting that the frame 201 of the current embodiment includes underlying T-bars, muntin bars, etc. into which the panes are installed. In the current embodiment, each lite 204 also includes a glazing ring 222. Many of these glazing rings 222 are formed from a plurality of stops 220 coupled together at their ends. Generally, the stops 220 are linear and/or elongated while the glazing rings 222 formed from them are often coupled together into a rectangular shape. These orthogonal glazing rings 222, though, do not limit the current disclosure since other shapes (for instance, those illustrated by arch top 112 of FIG. 1) are within the scope of the current disclosure.

FIG. 2 also illustrates that for sections of stiles 206 and rails 208 with lites 204 on both sides, stops 220 generally abut the corresponding sides of the muntin 210. Accordingly, if desired, a relatively thin web of the muntin 210 can be exposed with the stops 220 on either side providing a beveled or simulated caulk-bead-like appearance for the overall assembly. Of course if a jamb 214, threshold 216, or other frame member has a pane 204 on only one side, then a stop 220 can abut that frame member on that side.

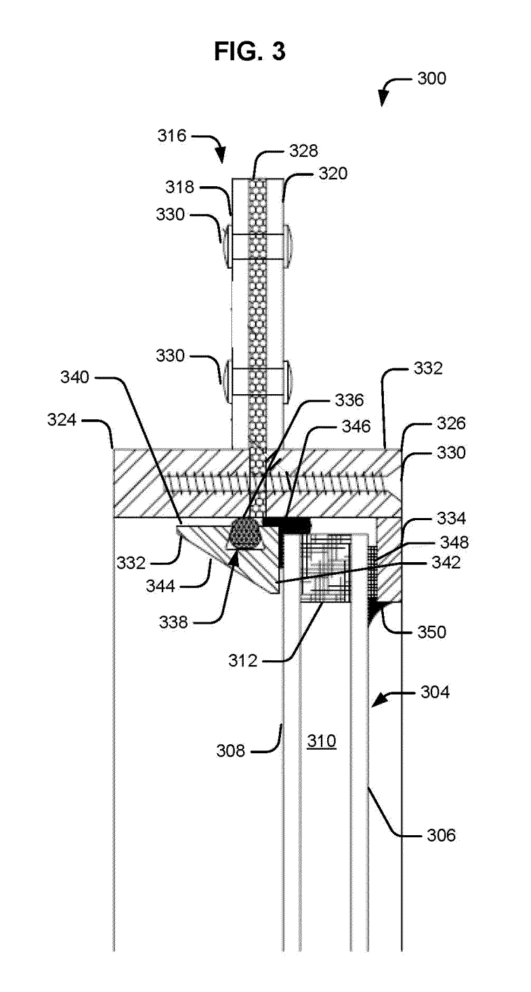

FIG. 3 illustrates a cross-sectional view of a thermally broken window frame. More specifically, FIG. 3 illustrates a thermally broken window frame 300 a lite 302, double-paned glass 304, an external pane 306, an internal pane 308, an air gap 310, a spacer 312, a mounting fin 316 an external fin half 318, an internal fin half 320, a frame member 322, an external frame half 324, an internal frame half 326, insulation 328, fasteners 330, a removable stop 332, a fixed stop 334, a spline 336, a (dovetail) groove 338, a frame-facing side 340, a pane-facing side 342, an exposed side 344, a wet seal 346, a butyl tape gasket 348, and caulk or other sealant 350. Thus, FIG. 3 illustrates three subassemblies of the overall thermally broken window frame 300: the lite 302, a portion of the frame, and the mounting fin 316.

The lite 302 as illustrated is a double-paned lite 302. Such double-paned lites 302 often exhibit better thermal characteristics than otherwise similar single-paned lites. These results occur because the air gap 310 between the external and external panes 306 and 308 provides relatively good insulation against thermal conduction from/to the exterior and interior sides of the lite 302. Of course, the air gap 310 could be filled with some other gas (such as argon) or it could be evacuated if desired). However, the relatively high resistance (or “R-value”) provided by the air gap 310 does depend to some extent on the window's ability to maintain that air gap 310. Should the air gap 310 narrow or should the panes 306 and 308 come into contact with one another, then the R-value of the pane might decrease. Accordingly, the spacers 312 along all (or some of the) edges of the lite 302 can aid in maintaining that air gap 310. Of course, the glass of each pane 306 and/or 308 can also contribute to the insulating effect of the lite 302 by limiting convective and/or radiative heat transfer through the lite 302. Radiative heat transfer can be limited particularly if one or both panes 306 and 308 are fabricated from low-E glass or a similar material. Of course, as is disclosed further herein, breathing or weep holes can be provided in the window such that any voids around the thermally broken window frame 300 can breath and/or drain as might be desirable. Of course, the terms “exterior” and “interior” are used herein merely to designate one side or the other of a window, lite, etc. and do not imply that any object so labeled be exterior to or interior to some structure.

Regarding the mounting fin 316, it can extend around the entire window frame and allow users to mount and/or attach the window to a structure such as a residence or office building. It can also provide holes for various fasteners 330 (rivets, nails, screws, bolts, etc.) to couple the external and internal frame halves 318 and 320 together. Of course, a piece of insulation 328 can be positioned and/or clamped there between to increase the thermal resistivity of the mounting fin 316 and related structures thereby “thermally breaking” the frame. That insulation 328 can extend to fill the gap between the external frame half 324 or stem and the internal frame half 326 or web so as to also improve the thermal performance of those and related structures. The thermally broken window frame 300 can also include a fastener of some sort to couple the two frame halves 324 and 326 to each other. Taken together, the frame halves 324 and 326 (along with certain other components of the thermally broken window frame 300) can hold the IG unit (the panes 306 and 308 and the spacers 312) in fixed relationship with the frame and the building (or other structure) to which they are attached.

With continuing reference to FIG. 3 the frame halves 324 and 326 form an “L” shaped channel (when viewed in cross section). The external pane 306 can be located generally adjacent to and/or abutting the external frame half 326 or web such that the frame-half or stem limits the movement of the external pane 306 in a direction arbitrarily designated here as “externally.” Since that external frame half 326 (of the frame 322) can be coupled to the building, a portion of it can be deemed a “fixed” stop 334. Of course, a butyl tape gasket 348 can be positioned between the external pane 306 and the fixed stop to hold the IG unitin place and/or to seal the external pane 306 against air, water, etc. infiltration and/or exfiltration. A bead of caulk 350, sealant or other finishing material can be run along the length of the fixed stop to further seal and/or finish the internal side of the lite 302.

The spacer 312 of the current embodiment can abut the internal pane 306 on its interior side with the exterior pane 308 abutting the opposite side thereof. Furthermore, a bead of wet seal 346 can adhere to and run along the length of the pane generally adjacent to and/or in between the exterior pane 308, the spacer 312, the frame halves 324 and 326, the insulator 328, and (as is further disclosed herein) the removable stop 332. Of course, one or more portions of the IG unit can be left without the wet seal 346 to allow water to evacuate and/or drain from below the pane. Otherwise, the wet seal 346 of the current embodiment fills much (if not all) of the voids between the pane and the frame(s) and the removable stop 332.

FIG. 3 also illustrates that the removable stop 332 (as part of a glazing ring or otherwise) can be generally positioned adjacent to and/or abut the external pane 308 or the external surface thereof. Moreover, the pane-facing side of the removable stop 332 can be generally adjacent to the external surface of the external pane 308 with the wet seal 346 being juxtaposed between the two surfaces. The exposed surface of the removable stop 332 can be positioned to be visible from the external side of the lite 302 and can appear to form a bevel with the lite 302 and/or the external pane 308. Meanwhile, the frame-facing side 340 of the stop can be generally adjacent to and/or abut the frame member (here the external frame half 324). Additionally, the groove 338 (defined by the frame-facing side 340 of the removable stop 332) can retain the spline 336. That spline 336 can be made from foam or some other material capable of providing a seal between the removable stop 332 and the external frame half 324. As such, it can possess a degree of mechanical resiliency.

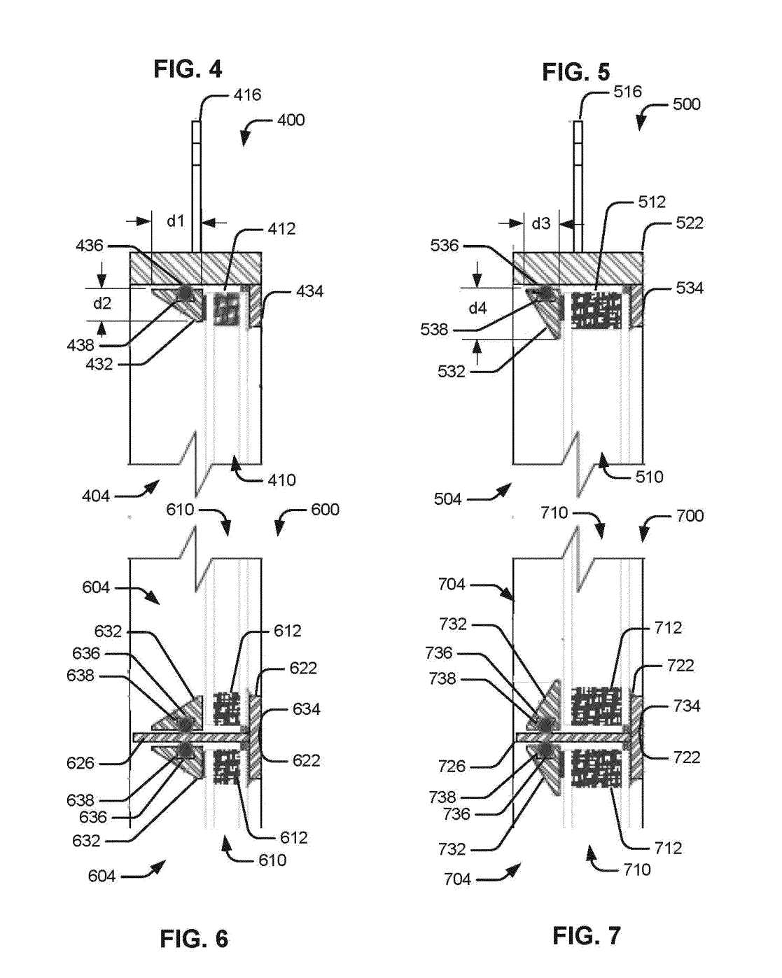

With reference now to FIGS. 2 and 3, the glazing ring 222 with the spline 336 positioned in the grooves 338 of its stops 332 can form a slight interference fit with the frame members (for instance, stiles 206, rails 208, frame members 322, etc.). Thus, the interference fit of the current embodiment can both compress the spline 336 to form a seal between the glazing ring 222 and the frame and can serve to hold the glazing ring 222 in place (particularly, while freshly applied wet seal 346 cures). At this juncture, it might be helpful to disclose several differing lites, panes, glazing rings, etc. with reference to FIGS. 4-7.

FIG. 4 illustrates a cross-sectional view of another double glazed window. More specifically FIG. 4 illustrates a double paned lite 404, an air gap 410, a spacer 412, a mounting fin 416, head 422, a removable stop 432, a fixed stop 434, a spline 436, and a groove 438. The embodiment illustrated by FIG. 4 moreover illustrates a single double-paned lite 404 which lies adjacent to a frame member such as a jamb or head as opposed to being surrounded by only muntins. Moreover, FIG. 4 illustrates that the double-paned lite 404 has relatively small, lightweight, window panes. These panes can be formed from glass or other material of no larger than about 20 square feet, with a thickness of no more than ¾ inch, and an overall weight of less than about 7 pounds. Thus, the stops 432 and/or glazing rings (formed therefrom) can be configured to hold such panes while hiding the spacers 412. To that end, the stops 432 can have a distance d1 defined by the frame-facing sides of the stops and a distance d2 defined by the pane-facing side of the stops. The distance d1 can be selected so as to provide stability for the glazing rings while the distance d2 can be selected for that purpose as well as being sufficient to hide the relatively small air spacers 412. Note that the spacers 412 of the current embodiment can be about ⅜ inches by about 11/16 inches and can run the length of the panes.

FIG. 5 illustrates a cross-sectional view of yet another double glazed window. More specifically, FIG. 5 illustrates a double paned lite 504, an air gap 510, a spacer 512, a mounting fin 516, head 522, a removable stop 532, a fixed stop 534, a spline 536, and a groove 538. In contrast to the embodiment of FIG. 4, the embodiment of FIG. 5 can be used with larger lites (and or panes) than those disclosed above. Of course, either embodiment can be used with either sized-lites without departing from the scope of the current disclosure. Nonetheless, the stops 532 shown in FIG. 5 can have distances d3 and d4 (corresponding to distances d1 and d2) selected for stability and/or the ability to hide the spacer 512. In the case of the spacer 512, its cross-sectional dimensions can be about ¾ inches by about 9/16 inches. Note that Table 1 lists some representative distances d1-d4.

FIG. 6 illustrates a cross-sectional view of another double glazed window. More specifically, FIG. 6 illustrates a double paned lite 604, an air gap 610, a spacer 612, muntin 622, a removable stop 632, a fixed stop 634, a spline 636, and a (dovetail) groove 638. In contrast to FIG. 4, FIG. 6 illustrates two lites with a muntin 622 there between rather than some other frame member such as a jamb or bottom/head rail. Moreover, in the embodiment illustrated by FIG. 6, both lites are formed with relatively smaller panes although that need not be the case.

FIG. 7 illustrates a cross-sectional view of still another double glazed window. More specifically, FIG. 7 illustrates a double paned lite 704, an air gap 710, a spacer 712, muntin 722, a removable stop 732, a fixed stop 734, a spline 736, and a (dovetail) groove 738. In contrast to the embodiment of FIG. 6, FIG. 7 illustrates a lite formed with relatively larger/heavier panes. Again, both lites are formed with the same panes although that need not be the case. Accordingly, the stops 432 and 632 happen to share dimensions (as do the spacers 412 and 612). The stops 532 and 732 similarly share dimensions (as do the spacers 512 and 712).

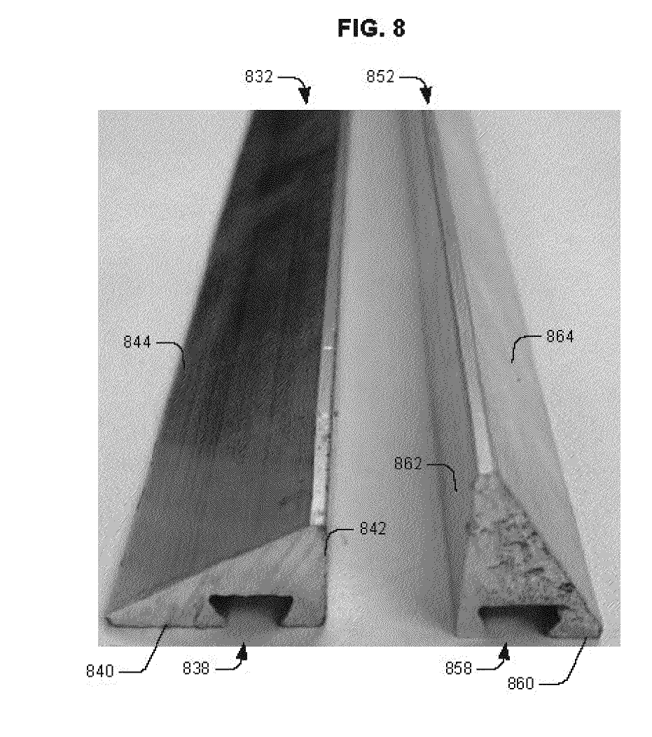

FIG. 8 illustrates a photograph of a pair of stops. More specifically, FIG. 8 illustrates stops 832 and 852 with differing dimensions (such as distances d1-d4) to hold panes of correspondingly differing sizes. Furthermore, these stops 832 and 852 have frame-facing sides 840 and 860, pane-facing sides 842 and 862, and beveled sides 844 and 864. The stops 832 and 852 also define the grooves 838 and 858 on their frame-facing sides 840 and 860. These grooves 838 and 858 happen to be dovetail-shaped although grooves of other shapes (for instance, square, rectangular, circular, oval, oblong, etc.) are within the scope of the current disclosure. FIG. 8 also illustrates that the stops 832 and 852 happen to be triangular in shape and define a generally solid cross-section. However, stops 832 and 852 of other shapes (for instance, square, rectangular, circular, oval, oblong, etc.) are within the scope of the current disclosure. Stops having non-solid cross-sections are also within the scope of the current disclosure in that stops of some embodiments are hollow and-or define one or more voids. Such (partially) hollow stops can weigh less than would otherwise be the case while maintaining much if not all of their sealing and structural characteristics. Additionally, FIG. 8 illustrates the ornamental appearance of the stops 832 and 852.

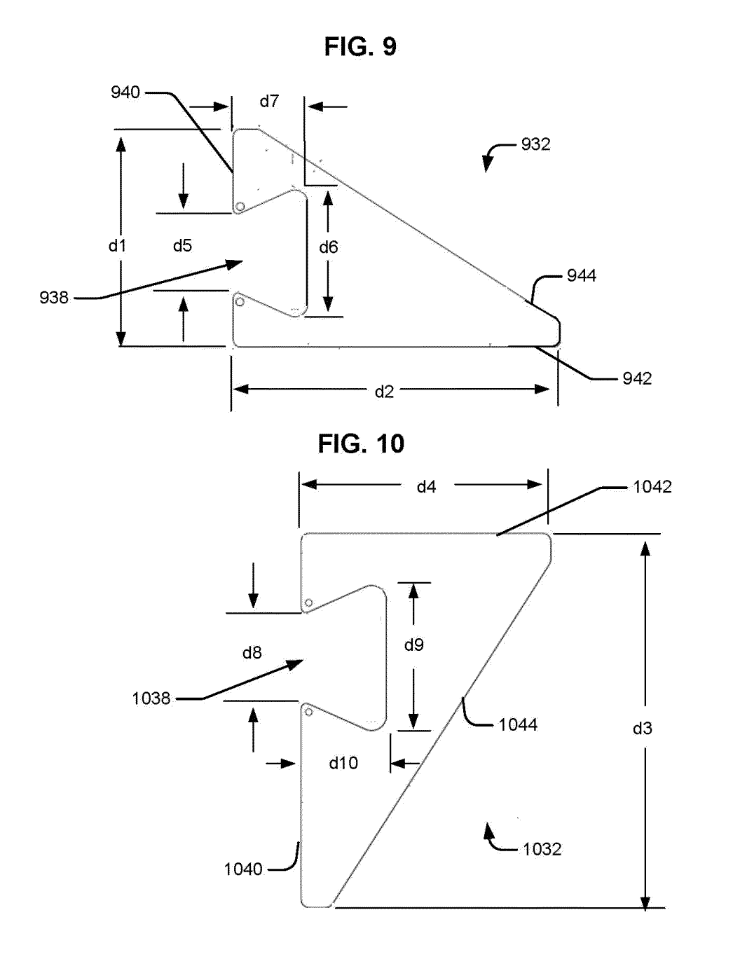

FIG. 9 illustrates an end elevation view of a stop. The stop 932 defines groove 938, frame-facing side 940, pane-facing side 942, and beveled side 944. Meanwhile, FIG. 10 illustrates an end elevation view of another stops. The stop 1032 defines groove 1038, frame-facing side 1040, pane-facing side 1042, and beveled side 1044. FIGS. 9 and 10 and Table 2 illustrate certain non-limiting dimensions of the stops 932 and 1032. More specifically, such stops can be used with about 0.02 to about 0.03 inch diameter closed-cell foam and/or rubber splines.

TABLE 1
Non Limiting Dimensions of Various Stops

| Distance | Length (inches) |
|---|---|
| d1 | 0.5 |
| d2 | 0.75 |
| d3 | 0.75 |
| d4 | 0.5 |
| d5 | 0.182 |
| d6 | 0.291 |
| d7 | 0.171 |
| d8 | 0.182 |
| d9 | 0.291 |
| d10 | 0.171 |

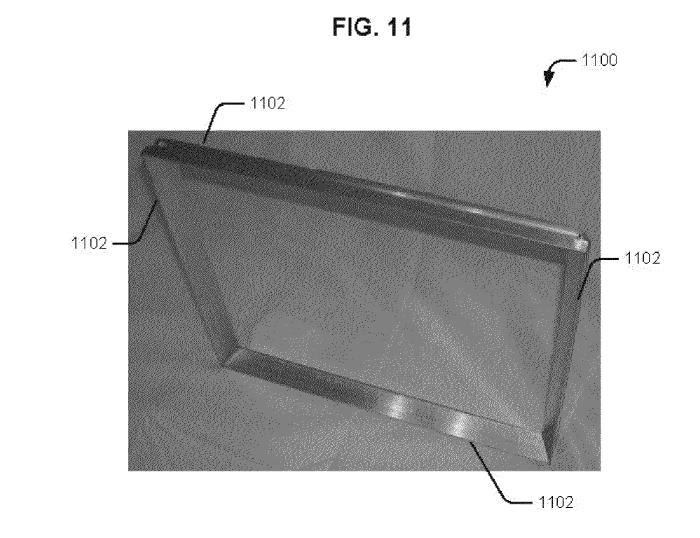

FIG. 11 illustrates a photograph of a glazing ring. More specifically, FIG. 11 illustrates that the glazing ring 1100 is formed from four stops 1102 joined orthogonally to one another by, for instance, welds. However, glazing rings of some embodiments could be joined by mechanical fasteners, brazes, solder, adhesive, etc. Note that the entire frame 201 (see FIG. 2) can be pre-fabricated in a shop, factory, etc. and transported as an integral unit to various construction sites. These integral frames 201 can be placed in rough openings (with corresponding shapes) and secured in place therein. Once the IG units (or other window panes) are installed in accordance with the current embodiment, wet seal 346 (see FIG. 3) can then be applied to the frames 201. The glazing rings 1100 (with their splines 336) can be inserted into the lites thereafter if desired. Thus, relatively little on-site construction can be required and workers can be employed in the process who do not necessarily have to possess high levels of skill. Moreover, FIG. 11 illustrates the ornamental appearance of the glazing ring 1100.

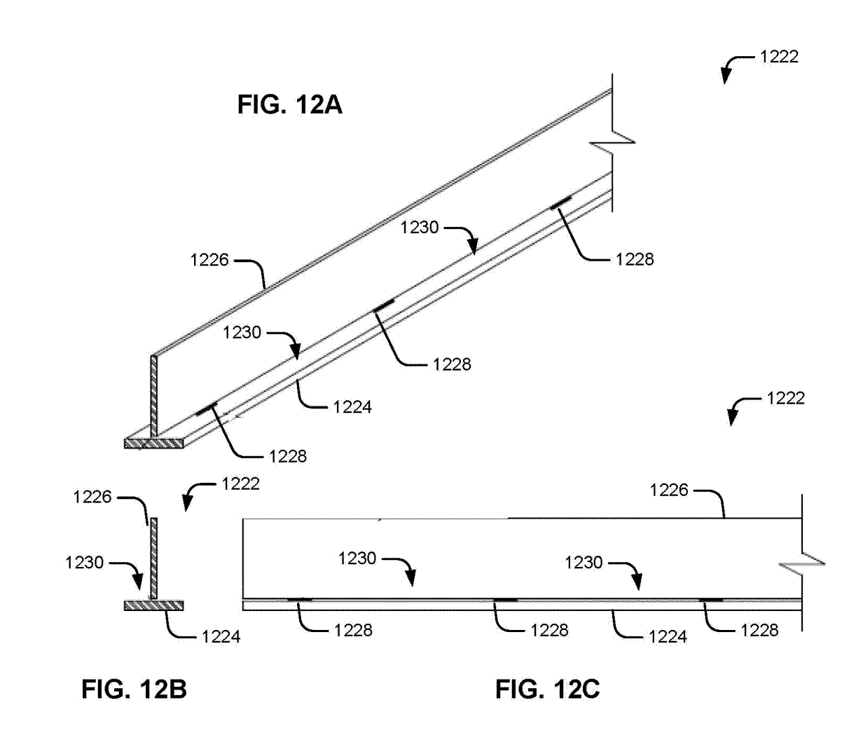

FIG. 12 illustrates a thermally “broken” muntin, T-bar, or other frame member. More specifically, FIG. 12 illustrates a muntin bar 1222, a flange 1224, a web 1226, various welds 1228, and corresponding air gaps 1230. In the current embodiment, the muntin bar 1222 is thermally “broke” so as to increase its insulating characteristics (and/or reduce its conductive characteristics). Thus, the flange 1224 and web 1226 are largely separated by the gaps 1230. Of course, these gaps 1230 conduct vary little heat across the depth of the muntin bar 1222 at least compared to the metallic material (or other material) of the muntin bar 1222. The welds 1228 of the current embodiment are of sufficient length/strength to mechanically couple the flange 1224 and web 1226 while also providing enough strength such that muntin bars 1222 of the current embodiment can be assembled into various windows along with various stops, air spacers, window panes, etc.

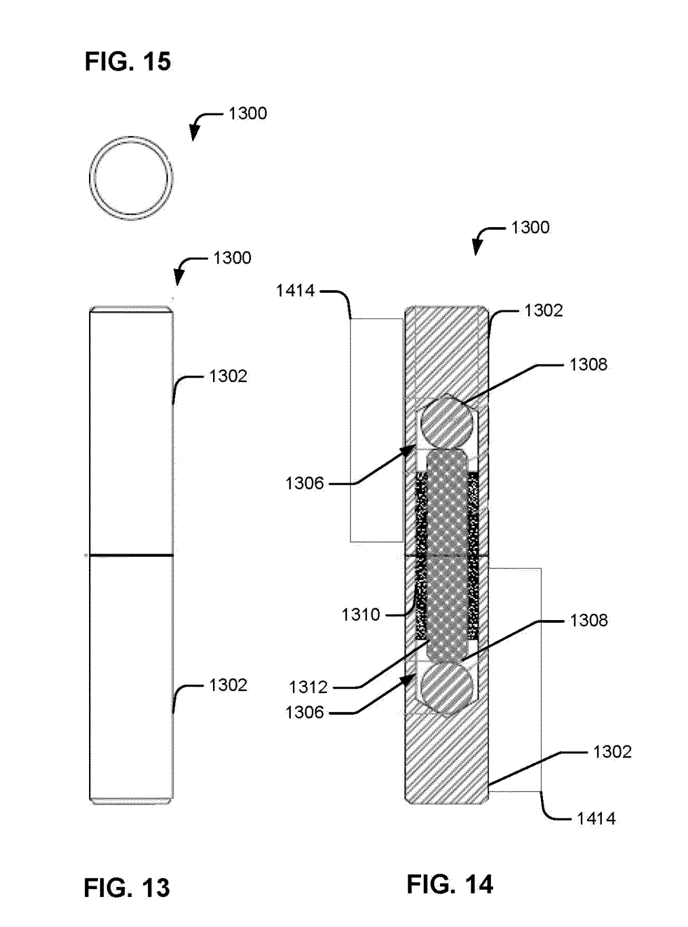

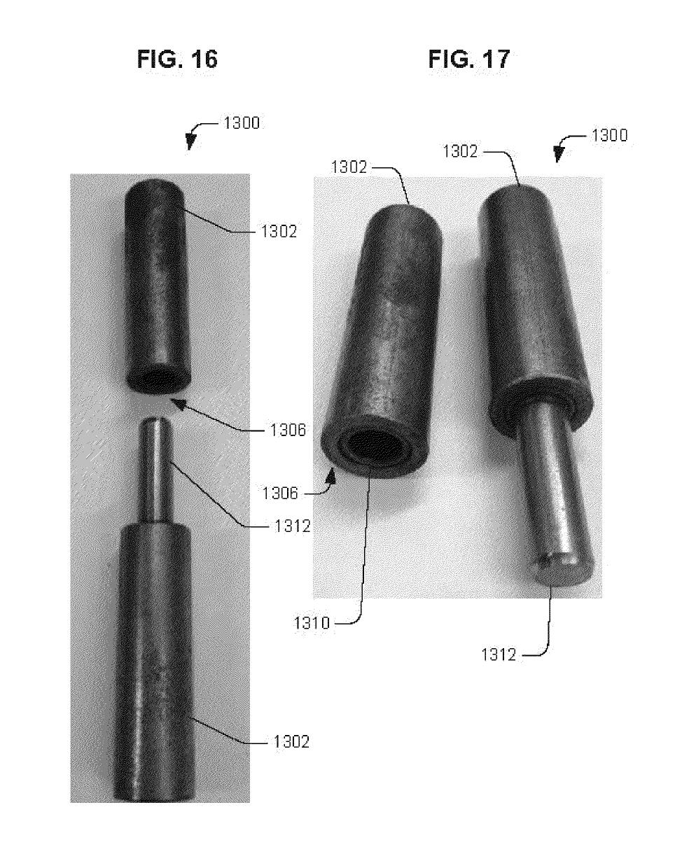

FIGS. 13-17 illustrate door/window hinges. More specifically, FIGS. 13-17 illustrates that the hinge 1300 includes (or defines) a pair of bodies or knuckles 1302, a pair of apertures 1306, a pair of ball bearings 1308, a pair of sleeve bearings 1310, a pin or shaft 1312, and a pair of wings 1414 (See FIG. 14). The wings 1414, of course, can be coupled to windows, doors, frames, and/or other structures to provide for pivotable coupling between the structures. That coupling can be by way of welds, mechanical fasteners, and/or the like. Although, as illustrated by FIG. 13, some hinges 1300 need not include wings 1414 and can instead be welded (or otherwise joined) to appropriate structures via weld-bridges (acting as wings). Meanwhile, the knuckles 1300 can couple to the wings 1414 and house the ball bearings 1318, the sleeve bearings 1310, and the shaft 1312. Indeed, these components can reside in the apertures 1306. Of course, the knuckles 1302 can be formed from round bar stock with the apertures 1306 machined therein. In some embodiments, though, other techniques can be used to form the knuckles 1302. For instance, forging and/or casting techniques can be used to form the knuckles 1302.

The ball bearings 1308 can be positioned at either end of the aperture 1306 and can serve to minimize friction between the shaft and the knuckles 1302. The shaft 1312 can reside between the ball bearings and within the central aperture of the sleeve bearing 1310. Since the sleave bearings can be self-lubricating the hinge 1300 can rotate with relatively little friction arising between the moving parts.

Moreover, the hinge 1300 of some embodiments can be manufactured so that a slight interference fit occurs between the shaft 1312 and the sleeve bearing 1310. Of course, the sleeve bearing 1310 can be pressed into the knuckles 1302 (or the aperture 1306 therein) so as to provide a seal between these structures. As a result, the aperture 1306 can be sealed such that it can hold a pressure and/or vacuum. For window frames of an appropriate weight, the hermetic seal might cause the frame to partially (or entirely) ride on a cushion of air thereby further reducing friction and/or cushioning the frame (and IG units thereof) against various shocks, forces, vibrations, etc.

Embodiments provide operable door panels and window sashes with swing hinges as disclosed further elsewhere herein. These hinges (and/or assemblies comprising them) can have better performance, durability, and longevity than heretofore possible. According to certain embodiments, upper and lower hinge bodies are machined from ¾inch solid round bar by drilling a ½ inch dia. hole 1 11/16 inch deep through the center of a 2½ inch long ¾inch round bar. A ½ inch stainless steel (SS) ball bearing is placed in the bottom of the resulting holes in the hinge bodies. Then a 1 inch long Super Oilite® or similar sleeve bearing (for instance, an SAE 863, ½ inch OD, ⅜ inch ID sleeve bearing) is pressed into the machined hole. These sleeve bearings trap the ball bearings in the bodies. In embodiments, the bearings are sintered bronze and iron, impregnated with SAE 30 petroleum lubricant and are therefor self-lubricating. A ⅜ inch diameter, 2⅜ inch long, SS shaft is then placed into the sleeve bearing. One body is slid onto each end of the SS shaft. This assembly of the current embodiment is welded between the door and the jam. Of course hinges of other configurations are within the scope of the current disclosure. However, hinges of the current embodiment allow the entire “down” load to rest at the contact points of the shaft and the ball bearings, and the entire cantilevered load to rest at the contact points between the side of the SS shaft and the inside of the sleeve bearing. Such configurations provide smoothly acting hinges that do not wear out, squeak, or need lubricating under many service conditions. Moreover, they can be maintenance free and can last for a homeowner's lifetime and/or beyond.

After fabrication, and in accordance with the current embodiment, the joints between steel components on the hinge assembly are filled with Bondo® and/or seam sealer. After the Bondo is sanded the assembly and the glazing rings are hung in a paint booth where they are coated with epoxy primer and epoxy top coat per user specified colors. Once the top coat is cured, the assembly and glazing rings are wrapped with foam, loaded on a trailer, and shipped to the customer in accordance with the current embodiment.

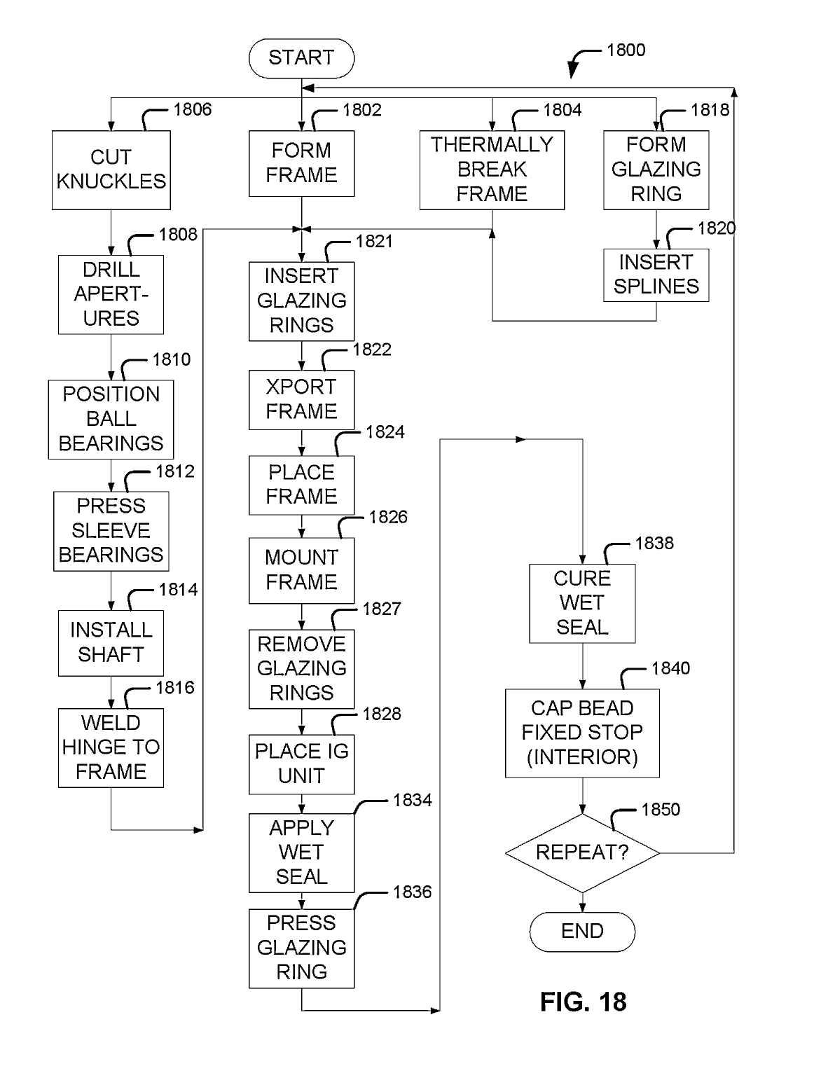

FIG. 18 illustrates a method of manufacturing windows. More specifically, FIG. 18 illustrates that the method 1800 includes three inter-related sets of activities. In one set, hinges 1300 are formed. In another set, glazing rings 1100 are formed. In the third set, window frames 201 are formed and installed on various structures.

With continuing reference to FIG. 18, the method 1800 can begin with forming or otherwise manufacturing a window frame 201. That frame 201 can be for a custom-designed or some type of more-or-less standard window and might include non-linear frame members such as those in an arch top 112. The manufacture of the frame 201 can include forming the various frame members such as the jambs, muntin bars, etc. from flat stock or the various channels can be received ready for assembly into the frame 201. See reference 1802. If the frame 201 (or portions thereof) is to be thermally broken, the gaps 1230 between the flange 1224 and the webs 1226 of the various frame members can be formed. For instance, flat stock can be tack welded together to form the frame members. See reference 1804.

At some point (for doors and windows that are to include hinges 1300), the hinges can be formed. In the current embodiment, this operation can include forming the knuckles 1302 including forming the apertures 1306 therein. For instance, circular bar stock of an appropriate size can be cut to the desired length for the knuckles and drilled out to form the apertures 1306 as indicated at reference 1806 and 1808.

Moreover, as method 1800 illustrates, the ball bearings 1308 can be positioned in the knuckles. See reference 1810. The sleeve bearings 1310 can also be pressed into, or otherwise inserted into the knuckles 1302 as indicated at reference 1812. Also, in accordance with the current embodiment, the shaft 1312 can be inserted into the sleeve bearings 1310 (see reference 1814). The resulting hinge(s) can then be coupled to the frame at selected locations thereon. See reference 1816. Of course, the manufacture of the hinges 1300 can proceed in parallel with other operations illustrated by FIG. 18.

Likewise, the glazing rings 1100 can be manufactured in parallel with many other portions of method 1800. Indeed, the stops 332 can be extruded or otherwise manufactured at reference 1818. Their manufacture can include forming the grooves 338 on the frame-facing sides 340. Furthermore, the extruded stops 332 can be cut to some desired length(s) and/or miter-cut at each end to facilitate their coupling to other stops 332. If one or more stops 332 are to have a shape other than linear, they can be placed in the dies of a bending machine (configured in accordance with the cross-sectional shape of the stops) and worked into the desired shape. The individual stops 332 can then be coupled to each other (by welds for instance) to form the glazing rings 1100 as indicated at reference 1818. Moreover, the splines 336 can be inserted into the grooves 338 of the glazing rings 1100 either at the factory or on site. Note that while splines 336 can be formed that would encircle their corresponding glazing rings 1100, in many cases, splines 336 can be formed for each of the individual stops 332 rather than the entire glazing ring 1100. See reference 1820.

The frame can be readied for shipment in part by, for instance, inserting the glazing rings into the lite openings of the frame. They can be (temporarily) secured therein so that each glazing ring will be in its respective lite opening when the frame is received on site or elsewhere. See reference 1821. When desired, the entire frame 201 can be packaged for transportation and moved to the construction site. The IG units, stops, glazing rings, etc. can be shipped with the frame 201, can be shipped locally, and/or can be formed at a separate location and shipped (by one or more manufactrers) to the construction site as well. See reference 1822. Note, that because the frames 201 can be assembled from muntin bars 1222 and welded together, they can be structurally sound enough to withstand the forces, vibrations, shock, etc. associated with typical transportation modes such as truck, rail, ship, etc.

With continuing reference to FIG. 18, the frames 201 can be placed in their corresponding rough openings at the construction site(s) as reference 1824 illustrates. Moreover, they can be attached to the building by using the mounting fins 316 and screws and/or other fasteners. For instance, the frames 201 can be nailed, riveted, screwed, etc. to the building. See reference 1826.

Further, the IG units can be removed from various lites so as to prepare the frame for assembly (or some portion thereof which can be performed on site). See reference 1827. Moreover, one or more IG units can be placed in their respective lite openings including positioning butyl tape gaskets or other sealing systems therewith. See reference 1828. When desired, beads of wet seal 346 can be spread along the frame members for the lites as indicated at reference 1832. Moreover, the glazing rings 1100 can be pressed into the lites and held in place (if desired) while the wet seal 346 cures. See reference 1836 and 1838 respectively. For some windows, a cap bead can then be applied to the interior of the IG unit to finish the same as indicated at reference 1848. Of course, method 1800 can be repeated in whole or in part. See reference 1850.

Embodiments therefore provide superior window and door frames which can be manufactured at a central factory, shop, etc. and transported to various construction sites. The frames of the current embodiment can be structurally sound and enable simple, quick, and efficient installations of windows and doors. Moreover, the resulting windows can be true divided lite windows with slimmer, more attractive frames. Further still, these windows can be easier to maintain and can be thermally broke if desired. In addition, or in the alternative, embodiments provide structurally and/or operationally superior hinges.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. A stop for securing a window pane against a frame member in a window, the stop comprising:
an extruded and elongated stop body defining a longitudinal axis,
a side adapted to face the window pane,
a side adapted to face the frame member,
a side at least a portion of which forms acute angles between the pane-facing side and the frame member-facing side, and
a generally solid and triangular cross-section as seen when viewed in a direction generally parallel to the longitudinal axis wherein the frame member-facing side further defines a groove generally parallel to the longitudinal axis and is adapted to receive a spline whereby the spline to form a seal between the stop and the window pane and whereby the window-stop to create a beveled surface between the frame member and the window pane.

2. A stop for securing a window pane against a frame member in a window, the stop comprising:
an elongated stop body defining a longitudinal axis,
a side adapted to face the window pane,
a side adapted to face the frame member, and
a side at least a portion of which forms acute angles between the pane-facing side and the frame member-facing side, wherein the frame member-facing side further defines a groove generally parallel to the longitudinal axis and which is adapted to receive a spline whereby the spline to form a seal between the stop and the window pane.

3. The stop of claim 1 further defining a generally solid cross-section when viewed in a direction generally parallel to the longitudinal axis.

4. The stop of claim 3 wherein the cross-section is triangular.

5. The stop of claim 1 wherein the stop is extruded.

6. The stop of claim 1 wherein the stop is orthogonally coupled to three other stops whereby the stops form a glazing ring.

7. The stop of claim 1 wherein the stop is further adapted to be installed in one or more of a window or a door.

8. The stop of claim 1 wherein the groove is a dovetail groove.

9. The stop of claim 1 further comprising the spline.

10. A glazing ring for securing a window pane against a frame member in a window, the stop comprising:
a first stop; and
a second stop, at least one of the stops defining
an elongated stop body defining a longitudinal axis,
a side adapted to face the window pane,
a side adapted to face the frame member, and
a side at least a portion of which forms acute angles between the pane-facing side and the frame member-facing side, wherein the frame member-facing side further defines a groove generally parallel to the longitudinal axis and which is adapted to receive a spline whereby the spline to form a seal between the stop and the window pane.

11. The glazing ring of claim 10 wherein at least one window-stop further defines a generally solid cross-section when viewed in a direction generally parallel to the longitudinal axis.

12. The glazing ring of claim 11 wherein the cross-section is triangular.

13. The glazing ring of claim 10 wherein at least one stop is extruded.

14. The glazing ring of claim 10 wherein the stops are orthogonally coupled to each other.

15. The glazing ring of claim 10 wherein at least one stop is further adapted to be installed in one or more of a window or a door.

16. The glazing ring of claim 10 wherein the groove is a dovetail groove.

17. The glazing ring of claim 10 wherein at least one stop further comprising the spline.

18. The glazing ring of claim 10 further comprising a third and a fourth stop.

19. The glazing ring of claim wherein the glazing ring is installed in a window including the frame member.

20. The glazing ring of claim 19 wherein the frame member is thermally broken.
